(19) United States
(12) Patent Application Publication
(10) Pub. No.: US 2022/0248738 A1
(43) Pub. Date: Aug. 11, 2022

(54) NUTRITIVE COMPOSITIONS WITH SECRETED IgA, MILK FAT GLOBULE MEMBRANE COMPONENTS AND/OR BIFIDOBACTERIUM

(71) Applicant: Evolve BioSystems, Inc., Davis, CA (US)

(72) Inventors: David KYLE, Davis, CA (US); Samara FREEMAN-SHARKEY, Davis, CA (US); Bethany HENRICK, Davis, CA (US)

(73) Assignee: Evolve BioSystems, Inc., Davis, CA (US)

(21) Appl. No.: 17/630,018

(22) PCT Filed: Jul. 27, 2020
(86) PCT No.: PCT/US20/43756

§ 371 Date: Jan. 25, 2022

Related U.S. Application Data
(60) Provisional application No. 62/879,288, filed on Jul. 26, 2019.

(51) Int. Cl. A23L 33/19; A23L 33/115; A23L 33/135; A23L 33/21; A23L 33/00

(52) U.S. Cl. CPC A23L 33/19; A23L 33/115; A23Y 2300/45; A23L 33/21; A23L 33/40; A23L 33/135

(57) ABSTRACT

This disclosure describes compositions of one or more components including milk fat globule membranes (MFGM) complexes, milk fat globules (MFG), commensal organisms, SlgA, recombinant SlgA (rSlgA), triglycerides or oils, and mammalian milk oligosaccharides (MMO) and the use of such compositions. The reconstituted MFGM component of the disclosed invention may come from an animal source, particularly from a mammalian source, including from the processing of buttermilk.

### FIELD OF INVENTION

The inventions described herein generally relate to compositions and uses of milk fat globule membrane complex (MFGM)-enriched complexes to store, protect and deliver commensal bacteria, milk oligosaccharides, and/or natural or recombinant proteins and enzymes to the gut of a mammal. This is intended to assist with the colonization of beneficial microorganisms and the suppression of potential pathogens or toxins as well as support the development of the immune system of that mammal. The artificial or reconstituted milk fat globules (MFG) may include additional proteins, glycopeptides or glycoproteins or glycolipids and oils. The proteins may be enzymes and may be protein fragments with a defined function. The MFG may also have secretory immunoglobulin A (SIgA). The SIgA may be spatially separated from the bacteria. The SIgA may also be customized or recombinant SIgA. These complexes are given to a mammal in need of intestinal maturation or repair or in cases where the intestinal microbiome may have been disrupted.

### BACKGROUND

Mammalian milk lipids are secreted in a unique manner by specialized cells of the lactating mammary gland. A milk fat globule (MFG) is constructed and released into the glandular lumen by these specialized cells, and it is surrounded by a phospholipid trilayer containing associated proteins, carbohydrates, and lipids derived primarily from the membrane of the secreting mammary cells. This trilayer is referred to as a milk fat globule membrane (MFGM). The inner core of the MFG is composed predominantly of triacylglycerols and are the dominant lipids in the MFG. The MFG is the primary source of fat in mammalian milk, which can be at a level of 3-5% in human milk and is a key source of energy for the growing neonate. This process is distinct from lipid secretion mechanisms used by any other non-mammary cells in the body, making MFGM unique to milk (https://en.wikipedia.org/wiki/Milk_fat_globule_membrane July, 2019).

Immunoglobulin A (IgA) is the first line of defense in the resistance against infection, by inhibiting bacterial and viral adhesion to epithelial cells and by neutralization of bacterial toxins and virus, both extra- and intracellularly. A newborn infant's capacity to generate mucosal-produced immunoglobins begins at birth, is dependent on its interaction with the gut microbiome, and develops slowly in the first year of life. Maternal immunoglobins are provided to the infant through breast milk, and the predominant Ig in human milk is IgA, most of which is in the form of Secretory IgA (SIgA), with smaller amounts of IgG and IgM. Maternal IgAs are produced by plasma cells in the gut of the mother and animal studies have suggested that the release of IgA in the milk is the result of migration of B Cells from the mother's intestine to the mammary gland via an enteromammary link (Rajani Front. Pediatr., 7 Aug. 2018 |https://doi.org/10.3389/fped.2018.00218). SIgA has an important role in mediating the adaptive humoral immune defense at mucosal surfaces. SIgA is always oligomeric in structure, primarily dimeric, and the polymers are linked by additional polypeptide chains, including a 15 KD joining chain (J chain) and a 70 KD secretory component chain produced in epithelial cells.

The gut microbiome is an ecological community of commensal, symbiotic, and pathogenic microorganisms found in the gut. Commensal bacteria have a mutualistic relationship with the host in that they provide some functionality that is beneficial to the host and vice versa. In nearly all cases, the mutual benefit provided by the bacterium is unknown and bacteria that are able to find a specific nutritional niche in the gut ecosystem (i.e., they are engrafted) and do not cause harm to the host, are also considered to be a gut commensal.

SIgA and a covalently bound probiotic in a complex with each other has been described (Benyacoub etal U.S. Pat. Nos. 9,173,937 and 9,629,908) for treating non-viral infections or inflammation.

### SUMMARY OF INVENTION

This disclosure describes compositions of one or more components including milk fat globule membranes (MFGM) complexes, milk fat globules (MFG), commensal organisms, SIgA, recombinant SIgA (rSIgA), triglycerides or oils, and mammalian milk oligosaccharides (MMO) and the use of such compositions.

The reconstituted MFGM component of the disclosed invention may come from an animal source, particularly from a mammalian source, including from the processing of buttermilk. The MFGM may additionally comprise glycolipids, phospholipids, oligosaccharides and/or glycoproteins from any source or otherwise synthetically derived. In some embodiments of this invention the MFGM may be microbially derived. The inventors further contemplate the use of effective homologues of MFGM in the disclosed invention. The herein disclosed invention may comprise any use of a phospholipid bilayer or trilayer for the delivery of a commensal organism and/or SIgA.

The MFGM component of the herein disclosed invention may further be associated with an oil. The MFGM may or may not encapsulate the oil component. Such oil may be selected from any food-grade oil from any source whether natural originating in a plant, animal, or microbe; or synthetically created. In preferred embodiments of this invention the oil is selected from medium chain triglyceride (MCT) oil, sunflower oil, docosahexaenoic acid (DHA) or arachidonic acid (ARA)-containing oils, and/or mineral oil. In any embodiment of this invention the MFGM may be purified and/or dried. The MFGM complex and oil may be homogenized with a commensal organism and left in suspension or dried.

This disclosure further describes a composition comprising MFGM with an associated SIgA component. The SIgA used in the herein disclosed invention may come from a variety of sources and take any of a number of paratopes or antigens selected for a particular aspect of the problem organism to render it less able to survive in an intestinal niche. The SIgA may be of mammalian origin, including bovine, and may further be purified from mammalian milk. The SIgA utilized in this invention may also be sourced from the production of buttermilk. The SIgA may further come from a recombinant microbial source. The SIgA may further be synthetically derived. Functional homologues of SIgA are also contemplated for use in the herein disclosed invention. Moreover, the SIgA may be directed against specific targets such as, but not limited to, an enteric pathogen (bacterial, archaeal, and/or fungal) or virus. An embodiment of this invention utilizes SIgA targeted specifically at bacteria in the phylum Firmicutes. Further embodiments of this invention utilize SIgA targeted specifically at bacteria within the genus Enterococcus. In one or more embodiments of this invention the SIgA used is directed against one or more of Staphylococcus sp, Escherichia sp, Clostridium sp., rotavirus, and/or Malassezia sp. In preferred embodiments of this invention there may be a variety of such targeted SIgA molecules associated with each treatment.

In one or more embodiment of the herein disclosed invention a mixture of SIgA paratopes is utilized which is formulated in accordance with geographic trends. For example, a mixture of SIgA paratopes may be selected based on diarrheal disease common in a geographic region or an SIgA mixture is utilized that is tailored specifically to a patient's microflora. For example, a health care provider may devise a composition of SIgA paratopes for use in this invention based on knowledge of the patient's intestinal microbial community. In such a use the SIgA composition would likely be selected to target undesirable taxa found in the patient's gut thereby helping to return the microbial community to a healthy state. Further embodiments of this invention include utilizing SIgA that is targeted toward antibiotic resistant microorganisms.

The SIgA component of this invention may or may not be chemically bound to the MFGM component. In some embodiments of this invention the SIgA is chemically bound to the MFGM component. In such embodiments the SIgA component may be bound to the MFGM component via O-linked glycans so long as it is not bound via the SIgA component's epitope-binding site.

Further embodiments of this invention include the formation of an “inside-out” MFG. Such MFGs exhibit a phospholipid bilayer or trilayer with the bilayer component facing the lumen of the globule and the monolayer facing the outside of the globule. Such configuration of the MFG would exhibit a nonpolar exterior, while the lumen surface will polar.

SIgA binding as well as globule formation may have the effect of spatially separating the SIgA component from any commensal bacteria component. Such embodiment may consist of filling the MFGM component with a Bifidobacterium-containing oil, thereby creating artificial globules, followed by resuspension in an aqueous solution. Such aqueous solution may optionally contain SIgA. The artificial globules may further be coated with freeze-dried SIgA before resuspension in the aqueous solution. In preferred embodiments such freeze-dried SIgA is recombinant.

In some embodiment, compositions comprise a MFGM component with a commensal microorganism component. Such embodiments optionally further include an SIgA component. Such embodiments may be prepared by homogenizing isolated and concentrated MFGs in the presence of commensal bacterial species such as, but not limited to, Lactobacillus, Bifidobacterium, and Pediococcus. Bifidobacterium may be from species such as B. adolescentis, B. animalis, B. animalis subsp. animalis, B. animalis subsp. lactis, B. bifidum, B. breve, B. catenulatum, B. longum, B. longum subsp. infantis, B. longum subsp. longum, B. pseudocatanulatum, B. pseudolongum. The Lactobacillus may be from species, such as L. acidophilus, L. antri, L. brevis, L. casei, L. coleohominis, L. crispatus, L. curvatus, L. fermentum, L. gasseri, L. johnsonii, L. mucosae, L. pentosus, L. plantarum, L. reuteri, L. rhamnosus, L. sakei, L. salivarius L. paracasei, L. kisonensis, L. paralimentarius, L. perolens, L. apis, L. ghanensis, L. dextrinicus, L. shenzenensis, L. harbinensis. The Pedicoccus may be selected from the group: P. acidilactici, P. argentinicus, P. claussenii, P. pentosaceus, P. stilesii, P. parvulus, or P. lolii. The Lactobacillus may be preferably selected from species L. plantarum, L. rhamnosus, and/or L. reuteri. The Pediococcus may be preferably selected from P. acidiliti. The Bifdobacterium may be preferably selected from species such as B. longum, B. breve, or more preferably B. longum subsp. infantis, or B. longum subsp. longum. In a more preferred embodiment, the Bifidobacterium may be activated by a process of contacting the Bifidobacterium with an activating agent such as described in International Patent Publications WO 2016/065324 published Apr. 28, 2016 and WO 2019/143871 published Jul. 25, 2019 (incorporated here by reference). In other embodiments, the B. infantis is H5 competent, and more specifically it is B. infantis EVC001 and more specifically the B. infantis activated deposited under ATCC Accession No. PTA-125180. The homogenized compositions can be used directly or dried to a powder in the presence or absence of cryoprotectants.

In one or more embodiments of the herein disclosed invention the artificial globule or MFGM, additionally comprising one or both of a commensal microorganism component and an SIgA component, further comprises one or more of mammalian milk oligosaccharides, such as but not limited to lacto-N-biose (LNB), N-acetyl lactosamine, lacto-N-triose, lacto-N-tetraose (LNT), lacto-N-neotetraose (LNnT), fucosyllactose (FL), lacto-N-fucopentaose (LNFP), lactodifucotetraose, (LDFT) sialyllactose (SL), disialyllacto-N-tetraose (DSLNT), 2′-fucosyllactose (2FL), 3′-sialyllactosamine (3SLN), 3′-fucosyllactose (3FL), 3′-sialyl-3-fucosyllactose(3S3FL), 3′-sialyllactose (3SL), 6′-sialyllactosamine (6SLN), 6′-sialyllactose (6SL), difucosyllactose (DFL), lacto-N-fucopentaose I (LNFPI), lacto-N-fucopentaose II (LNFPII), lacto-N-fucopentaose III (LNFPIII), lacto-N-fucopentaose V (LNFPV), sialyllacto-N-tetraose (SLNT), their derivatives, or combinations thereof. The oligosaccharides may include: (a) include one or more Type II oligosaccharide core where representative species include LnNT; (b) one or more oligosaccharides containing the Type II core and GOS in 1:5 to 5:1 ratio; (c) one or more oligosaccharides containing the Type II core and 2FL in 1:5 to 5:1 ratio; (d) a combination of (a), (b), and/or (c); (e) include one or more Type I oligosaccharide core where representative species include LNT (f) one or more Type I core and GOS in 1:5 to 5:1 ratio; (g) one or more Type I core and 2FL in 1:5 to 5:1 ratio; and/or (h) a combination of any of (a) to (g) that includes both a type I and type II core. Type I or type II may be isomers of each other. Other type II cores include but are not limited to trifucosyllacto-N-hexaose (TFLNH), LnNH, lacto-N-hexaose (LNH), lacto-N-fucopentaose III (LNFPIII), monofucosylated lacto-N-Hexose III (MFLNHIII), Monofucosylmonosialyllacto-N-hexose (MFMSLNH). The homogenized compositions can be used directly or preferably freeze dried to a powder form for stabilization in the presence or absence of cryoprotectants. In other embodiments, a prebiotic or other excipient such as, but not limited to galactooligosaccharide (GOS), fructooligosaccharide (FOS), xylooligosaccharide (XOS), polydextrose (PDX), and maltodextrin may be used in place of or together with any mammalian milk oligosaccharides.

Any embodiment of the herein disclosed invention may further comprise one or more proteins with glycans linked through an asparagine (N-glycans). Such as N-glycans of glycoproteins, including but not limited, to whey protein, lactoferrin, and/or soy protein. The glycans may or may not be removed from the protein portion.

Any embodiment of the herein disclosed invention may further comprise a blend of nutritional components designed for human or animal use. In preferred embodiments of this invention the nutrient blend comprises a source of amino acids such as, but not limited to indole lactate, tryptophan, lysine, proline, methionine and taurine. Further embodiments may include a blend of nutritional components comprising either proteins and peptides including, but not limited to, a milk protein, a milk peptide, a vegetable protein, and a vegetable peptide. Further embodiments may include a source of essential vitamins and cofactors including, but not limited to vitamins A, C, D, E, K, B1, B2, B3, B6, B12, pantothenic acid, biotin and folic acid.

Any embodiment of the herein disclosed invention may be used as a medicament taking the form of a capsule, tablet, or sachet. A preferred embodiment of this invention comprises a medicament taking the form of an oil suspension, wherein the oil component can be safely consumed by a mammal and may include, but is not limited to a plant oil, animal oil, microbial oil, and an artificially restructured oil.

The herein disclosed invention includes a method of preparing MFGM lipids for delivery to the mucous layer of the gut epithelium of a mammal, said method comprising the steps of (a) preparing MFG, artificial fat globules (AFG) or MFGM lipids; (b) combining MFG, AFG, or MFGM lipids with at least one commensal organism and/or recombinant sIgA to produce an emulsion of liposomes from the composition; and (d) drying the emulsion to form a dried composition. SIgA utilized in this method may be from a recombinant bacterial, yeast, or other fungal source and is specific to an epitope of an antigen. Such recombinant sIgA may then be combined with MFG, AFG, or MFGM in a ratio from 1:1,000,000 to 1,000,000:1. Such method may additionally comprise the addition of a commensal organism in a purified stable form. Such commensal organism may be selected from Bifidobacterium such as B. infantis, B. breve, B. bifidum, B. longum, and B. lactis; a Lactobacillus such as L. plantarum, L. rhamnosus, and L. reuteri; or a Pedicoccus such as P. acidolacti. In a preferred embodiment of this method the commensal organism is B. infantis, which may be activated and/or it is B. infantis EVC001 deposited under ATCC Accession No. PTA-125180. At least one mammalian milk oligosaccharides including, but not limited to LNB, LNT, LNnT, 3′ SL or 6′ SL, 2FL or 3-FL or LNT/LnNT derivatives with at least one or at least 2 fucose residues may additionally be added to the composition used in this method.

The resulting composition of the above described method may be used, optionally in a dried form, to treat a human having chronic gut inflammation. In some embodiments, it may further deliver a commensal organism to a subject in need of colonization or recolonization with said commensal organism. In some embodiments it may further deliver a targeted recombinant SIgA to a mucosal membrane of a mammal, as well as the preparation of such targeted SIgA to an undesirable organism found in a subject's gut. In one or more embodiments, the SIgA may be a recombinant secretory immunoglobulin A (rSIgA). In some embodiments, the composition is provided to a nursing mammal, a weaning mammal, or an adult mammal.

In some embodiments of this invention any composition herein disclosed may be administered to a mammal, where such mammal may be in need of treatment or prevention of intestinal disease caused by a microorganism or microorganisms. These compositions and methods may also be administered to a mammal in need of restoring the gut microbiome and/or reducing inflammation. Such treatment may be administered to a mammal to treat an infection in that individual where the infectious agent may antibiotic resistant to one or more antibiotics. Such treatment may be used to treat a Staphylococcus aureus or Clostridium difficile infection, antibiotic resistant or otherwise. Administration of such methods and compositions may lead to the acidification of the mammal's gut. Administration of such methods and compositions may improve the growth rate of the mammal measured by kilograms/day, Z scores, such as weight for age (WAZ), length for age (LAZ) or (weight for length) WLZ. In some embodiments of this invention the mammalian subject herein referenced is a human.

In some embodiments of the invention the MFG/commensal bacterium product comprises lecithin, a phospholipid. In some embodiments oils are added to homogenize the mixture. In some embodiments, the liquid mixture is oil and aqueous liquid, such as water. The composition may further comprises one or more of SIgA or rSIgA. The lecithin may be of soy origin. The compositions can be used directly or preferably dried to a powder form for stabilization in the presence or absence of cryoprotectants and/or other emulsifiers.

In some embodiments of the invention the MFGM/commensal bacterium composition further comprises a triglyceride oil such as but not limited to DHA-containing triglycerides, ARA-containing triglycerides, medium chain triglycerides, a vegetable oil, a restructured vegetable oil, or mixtures thereof.

In another embodiment of the invention, the MFGM complex is blended in powder form with the commensal bacteria. In a preferred embodiment the MFGM/commensal bacterial powder is further blended with a triglyceride oil comprising DHA-containing triglycerides, ARA-containing triglycerides, medium chain triglycerides, a milk oil, a vegetable oil or a restructured vegetable oil. The resulting mixture can be emulsified with water and freeze dried to produce a stable powder. In a preferred embodiment the mixture is further blended with cryoprotectants, mammalian milk oligosaccharides, SIgA and/or rSIgA. The final MFGM complexes that are homogenized compositions can be used directly or preferably freeze dried or spray dried to a powder form for stabilization in the presence or absence of cryoprotectants.

The novel compositions may be used in humans or other mammals to improve stability of the bacterial payload, target delivery of bacteria and SIgA to the upper and lower intestine, and to improve the microbiome and/or the function of the gut of a subject in need thereof. In one embodiment, the compositions are provided to a healthy mammal of any age

In some embodiment the compositions are provided to mammals of any age who are in need of a treatment to reduce inflammation in the gut or otherwise improve gut health.

In one embodiment, the compositions are provided to a healthy mammal of any age. In a preferred embodiment the compositions are provided to a human child (2-16 yr), and adult (16-70 yr) or a geriatric adult (70-100 yr). In a more preferred embodiment, the compositions are provided to a preterm infant, an infant (0-6 mo) or in infant (6-14 mo).

In some embodiment, the compositions are provided to infant mammals to protect the gut from opportunistic pathogen invasion (i.e., to provide colonization resistance) at a time where their adaptive immune system is developing. In a preferred embodiment, the infant is a human infant from age 0-24 months.

In some embodiment, the compositions are provided to infant mammals to lower the pH of the gut at a time where their adaptive immune system is developing. In a preferred embodiment the infant is a human infant from age 0-24 months. In some embodiments, compositions are used to lower the pH of the gut at a time when the subjects is in need of mucosal healing.

In another embodiment, the compositions are provided to infant mammals to reduce the carriage of antibiotic resistant genes and/or levels of endotoxin and/or chronic gut inflammation at a time where their adaptive immune system is developing. In a preferred embodiment the infant is a human infant from age 0-24 months. In some embodiments, compositions are used to reduce the carriage of antibiotic resistant genes and/or levels of endotoxin and/or chronic gut inflammation at a time when the subject is in need of mucosal healing.

In another embodiment, the compositions are provided to mammals of any age who are in need of a treatment to reduce inflammation in the gut. In a preferred embodiment the mammal is a human and the cause of inflammation can be an acute, chronic disease of autoimmune origin or otherwise, such as, but not limited to, necrotizing enterocolitis, diaper rash, colic, late onset sepsis, inflammatory bowel disease, irritable bowel syndrome (IBS), colitis, gut pathogen overgrowth (e.g., C. difficile), hospital acquired infections, asthma, wheeze, allergic responses, Type I Diabetes, Type II diabetes, celiac disease, crohn' s, disease, ulcerative colitis, multiple sclerosis, psoriasis, and atopic dermatitis.

In another embodiment the compositions can be provided to a non-human mammal of any age including, but not limited to pigs, cows, horses, dogs, cats, donkeys, camels, sheep, goats and rabbits. In another embodiment, the compositions are provided to non-human mammals for the prevention or treatment of gut inflammatory conditions. The non-human mammals may be newborn mammals, who are optionally nursing, or they may be food production animals, performance animals or domestic animals.

### DETAILED DESCRIPTION OF INVENTION

The inventors discovered that micelles or liposomes formed from components of the milk fat globule membrane (MFGM) can help protect and stabilize commensal microorganisms during long term storage and during intestinal transit. MFGM are useful carriers of additional functions and components that improve the effectiveness of establishing or restoring a gut microbiome. Furthermore, MFGM can alter the ability recombinant SIgA or rSIgA to be delivered to and interact with the intestinal epithelial barrier including but not limited to epithelial cells and dendritic cells. The invention serves to overcome a technical hurdle associated with the inappropriate (non-human) glycosylation pattern in rSIgA and the need for bacteria and, more specifically, commensal bacteria to appropriately stimulate the immune system. These inventions can be delivered alone in combination. Formulations may include a MFGM component with a commensal microorganism, a MFGM component with a recombinant SIgA or a MFGM component with both a commensal microorganism and a recombinant SIgA. In this last formulation, MFGM component acts as a barrier to separate the SIgA and commensal microorganism to prevent direct interaction during storage and transit.

A “milk fat globule or MFG ” means a globule that has at least a membrane structure similar to that of mammalian milk with a phospholipid bilayer or trilayer that has a polar surface and a non-polar lipid surface whether or not the components making up that layer come from dairy or non-dairy sources. The bilayer or trilayer may have proteins and/or glycoproteins, glycolipids inserted into the structure. “Milk fat globule membrane complex or MFGM” means any source of material that is collected from a mammalian milk source where the original structure is disrupted by milk processing steps, such as but not limited to pasteurization, homogenization or skimming steps. It may be used as fragments in a composition or used as a component to make new MFG that are considered synthetic or artificial regardless if they derive material from mammalian milk if they are substituted with non-milk triglycerides, or other additional components described herein. A MFGM complex means any combination that at least comprises membrane components such as phospholipids, but may also comprise at least one other component such as glycolipids, glycoproteins, proteins, oil, oligosaccharides, secretory IgA, bacteria. The complex may be an intact globule or may be fragments.

Secretory Immunoglobulin A (SIgA) are a dimerization of IgA1 or IgA2 and are antibodies that acts as the first line of defense in protecting the intestinal epithelium from enteric toxins and pathogenic microorganisms through immune exclusion. In this way SIgA blocks microorganisms and toxins from attaching to mucosal epithelial cells, thereby preventing surface damage, colonization, and subsequent invasion/colonization. Secretory IgA is typically a highly glycosylated dimer of IgA subtypes connected at the Fc portion of the antibody by the Secretory Component (SC) and J chain, which protects it from proteases and the harsh conditions of the gastrointestinal tract. Colostrum and milk contain high levels of SIgA and serve as the only source of passive immunity for a newborn infant. Yeast, microbial, algal and other systems exist to produce recombinant forms of sIgA to closely mimic those produced by the human or animal naturally. The recombinant forms, however, are likely to lack or have altered glycosylation patterns. The fragment antigen binding (Fab region) and/or the paratope of the antibody can be modified against specific pathogens or toxins. Recombinant antibodies can be either polyclonal or monoclonal

A commensal microorganism is one expected to be found or has been found in the intestinal tract of an individual. The microorganism is in a relationship where it derives food or other benefits from the host. A symbiont is a microorganism that has a mutually beneficial relationship with a host. The presence or absence of these commensal or symbiotic organisms may change with age, health status, or consumption of different food and fiber sources. Commensals and/or symbionts may be used as probiotics. Probiotics are microorganisms provided to a host for the purpose of improving any aspect of the health of the host and they may, in certain cases, significantly alter the host's gut microbiome.

A gut or intestinal microbiome is the total community of microorganisms residing in the gastrointestinal tract of an individual. It can include bacteria, yeast, and viruses. A microbiome may be measured with next generation sequencing technology using a sequencing depth to identify the family level, to the species or subspecies level, or to be able to look at specific gene functions (metagenomics) to establish the relative abundance or certain taxa or genes within the total microbiome. Individual genus or species' absolute abundance can be measured by quantitative polymerase chain reaction (qPCR) by using primers specific to the organism in question and normalizing to micrograms of feces or micrograms of DNA.

“Mammalian milk oligosaccharide” (MMO) is defined here as any oligosaccharide that exists naturally in any mammalian milk. MMO includes synthetic structures as well as those extracted or purified from sources other than mammalian milk so long as the compound mimics that found in mammalian milk in structure and/or function. That is, while MMOs may be sourced from mammalian milk, they need not be for the purposes of this invention. Human milk oligosaccharide” (HMO) is defined here as any oligosaccharide which exists in human milk. HMO includes synthetic structures as well as those extracted or purified from sources other than human milk so long as the compound mimics that found in human milk in structure and/or function. That is, while HMOs may be sourced from human milk, they need not be for the purposes of this invention. Sources of MMO may include colostrum products from various animals including, but not limited to cows, goats and other commercial sources of colostrum. It may include derivatives of whey permeate that contain MMO, human milk products that are modified through processes such as skimming, protein separation, pasteurization, retort sterilization may also be a source of MMO.

Oil means any edible, food grade oil that is appropriate for the target population and can be used to fill a milk fat globule, to emulsify a milk fat globule membrane fragment, and/or mix with a microorganism to form an oil-bacteria suspension.

### Complexes Containing MFGM

MFG may be purified from mammalian milk sources by processes known in the art, or synthetically derived using a variety of isolated protein or lipid components by proprietary processes. In the instant invention MFG are e customized to target specific conditions or age groups.

MFGM can come from any mammal including but not limited human, horse, cow, goat, sheep, donkey, and camel. The milk fat globule can be separated from buttermilk. The milk fat globule can be purified intact from any milk source, disrupted, and the components reassembled into micelles or liposomes. Artificial MFGM globules can be formed using a source of phospholipids, lecithin, an N-linked protein or N-linked protein fragment, an O-linked protein or O-linked protein fragment, with or without key enzyme active sites and transmembrane domains. Optionally the MFGM can contain a source of triglyceride.

In some embodiments, buttermilk is processed to collect the MFG, the globule structure is then disrupted and reformed with bacteria in the Triglyceride (TG) or oil core. In some embodiments, the MFGM is reconstituted from phospholipids, a purified, N-linked protein fragment containing a transmembrane domain and an O-linked protein fragment and mixed with the TG-B. infantis suspension. In some embodiments, intact purified enzymes are selected to confer additional functionality to the bacteria-MFGM-immune complex.

The central core of the micelle or liposome can contain triglycerides from sources such as, but not limited to, a medium chain triglyceride (MCT) oil, vegetable oils, DHA- or ARA-enriched oils, structured triglycerides, or mineral oil. The interior of the micelle or liposome may also contain a commensal bacterium. The bacteria contained in the micelle may be activated by a method described in (WO 2016/065324 published Apr. 28, 2016 and WO 2019/143871 published Jul. 25, 2019) (incorporated here by reference). In other embodiments, the globules of the composition are turned inside out such that the polar side is inside containing the SIgA in aqueous solution whereas the dormant commensal organisms are suspended in oil.

In some embodiments, a homogeneous suspension of the commensal organism suspended in an oil is mixed with reconstituted milk fat globule membranes to form globules where the oil and commensal organism is encapsulated in the center of the MFG. The resulting MFG or AFG containing oil and commensal organism in their center are referred in this document as “filled MFG” to distinguish them from other embodiments where the commensal organism and MFGM may be combined in alternative ways. In some embodiments, the filled MFG are separated from the oil mixture and freeze-dried under conditions known in the art that preserve the phospholipid structure and provide oxidative stability, such as suggested by Zhu (J Agric Food Chem. 2011 Aug. 24;59(16):8931-8. doi: 10.1021/jf201688w. Epub 2011 Aug. 1). In other embodiments, the filled MFG are incubated in a sterile aqueous solution. In some embodiments, the preferred commensal organism is an activated or non-activated Bifidobacterium longum such as, but not limited to, B. longum subsp. infantis. In other preferred embodiments, one or more different bacterial species fill the MFG center.

In some embodiments, a dried MFGM ingredient containing phospholipids, glycolipids, proteins or glycoproteins are mixed with one or more commensal organisms. The commensal organism may be selected from the group comprising the genus of Bifidobacterium, Lactobacillus, or Pediococcus. Bifidobacterium species may be selected from species such as B. adolescentis, B. animalis, B. animalis subsp. animalis, B. animalis subsp. lactis, B. bifidum, B. breve, B. catenulatum, B. longum, B. longum subsp. infantis, B. longum subsp. longum, B. longum subsp. suis, B. pseudocatanulatum, B. pseudolongum. Lactobacillus may be selected from species such as L. acidophilus, L. antri, L. brevis, L. casei (or Lacticaseibacillus casei), L. coleohominis, L. crispatus, L. curvatus, L. fermentum, L. gasseri, L. johnsonii, L. mucosae, L. pentosus, L. plantarum (Lactiplantibacillus plantarum), L. Reuteri (Limosilactobacillus reuteri), L. rhamnosus (Lacticaseibacillus rhamnosus), L. sakei, L. salivarius (Ligilactobacillus salivarius), L. paracasei (Lacticaseibacillus paracasei), L. kisonensis., L. paralimentarius, L. perolens, L. apis, L. ghanensis, L. dextrinicus, L. shenzenensis, L. harbinensis. Pedicococcus species may be selected from P. acidilactici, P. argentinicus, P. claussenii, P. pentosaceus, P. stilesii, P. parvulus, or P. lolii. One skilled in the art will recognize the bacteria is the same even if it has or undergoes a name change in the future.

The Bifidobacterium species or subspecies may be selected from the group that are typically associated with infants, such as B. infantis, B. breve and/or B. bifidum. In some embodiments, the infant Bifidobacterium species may be one that has transport mechanisms to internalize intact HMO (B. infantis) or ones that produce extracellular catabolic enzymes, such as B. bifidum or one with hybrid capabilities (B. breve).

In preferred embodiments, the commensal organism is Bifidobacterium longum subspecies infantis (B. infantis). In more preferred embodiments, the B. infantis is H5 competent, such as B. infantis EVC001 deposited under ATCC Accession No. PTA-125180. H5 competent refers to B. infantis that have all the genes in the H5 cluster including the genes Blon_2175-2177, responsible for the ABC transport system that enable growth on LNT and LNnT. When B. infantis are H5 is deficient they exhibited impaired growth on LNT, LNnT and pooled HMO [WO 2019/232284, published Dec. 5, 2019 and incorporated herein by reference]. In other embodiments a B. infantis that is H5 deficient may be more preferably used with 2FL and other HMO not related to LNT or LnNT.

In some embodiments, one or more Lactobacillus may be selected from the group consisting of food-associated Lactobacillus: L. acidophilus, L. brevis, L. casei, L. crispatus, L. curvatus, L. fermentum, L. pentosus, L. plantarum, and L. sakei or one or more Lactobaccilus may be selected from the the group consisting of host-associated Lactobacillus: L. antri, L. coleohominis, L. gasseri, L. johnsonii, L. mucosae, L. reuteri, L. rhamnosus, and L. salivarius.

In any of the embodiments, the commensal organism or probiotic bacteria may be administered to deliver a daily intake reported by colony forming units (CFU) delivered or consumed. The daily intake of 1 million CFU/gram of composition through 100 billion CFU/gram of composition is calculated as part of the diet. The CFUs may be delivered in a single serving or multiple servings per day. In preferred embodiments, the daily intake is at least 100 million, at least 300 million, at least 1 billion, at least 4 billion, at least 6 billion, at least 8 billion, at least 13 billion, or at least 18 billion CFU/gram of composition.

The commensal microorganism and any MFGM complex maybe blended and homogenized with the aid of one or more emulsifiers, such as a lecithin or milk phospholipids before freeze-drying. In some embodiments lecithin is homogenized with oil and bacteria. The homogenized compositions can be used directly or preferably as a dried powder form for stabilization in the presence or absence of additional cryoprotectants, such as mannitol, sorbitol, erythritol, threitol, trehalose, glucose and fructose, proline and/or alanine, polysaccharides or oligosaccharides.

Mammalian milk oligosaccharides may be included with the MFGM complex and the composition may include one or more of lacto-N-biose (LNB), N-acetyl lactosamine, lacto-N-triose, lacto-N-tetraose (LNT), lacto-N-neotetraose (LNnT), fucosyllactose (FL), lacto-N-fucopentaose (LNFP), lactodifucotetraose, (LDFT) sialyllactose (SL), disialyllacto-N-tetraose (DSLNT), 2′-fucosyllactose (2FL), 3′-sialyllactosamine (3SLN), 3′-fucosyllactose (3FL), 3′-sialyl-3-fucosyllactose(3S3FL), 3′-sialyllactose (3SL), 6′-sialyllactosamine (6SLN), 6′-sialyllactose (6SL), difucosyllactose (DFL), lacto-N-fucopentaose I (LNFPI), lacto-N-fucopentaose II (LNFPII), lacto-N-fucopentaose III (LNFPIII), lacto-N-fucopentaose V (LNFPV), sialyllacto-N-tetraose (SLNT), their derivatives, or combinations thereof. The oligosaccharides may include: (a) one or more Type II oligosaccharide core where representative species include LnNT; (b) one or more oligosaccharides containing the Type II core and GOS in 1:5 to 5:1 ratio; (c) one or more oligosaccharides containing the Type II core and 2FL in 1:5 to 5:1 ratio; (d) a combination of (a), (b), and/or (c); (e) include one or more Type I oligosaccharide core where representative species include LNT; (f) one or more Type I core and GOS in 1:5 to 5:1 ratio; (g) one or more Type I core and 2FL in 1:5 to 5:1 ratio; and/or (h) a combination of any of (a) to (g) that includes both a type I and type II core. Type I or Type II may be isomers of each other. Other type II cores include but are not limited to trifucosyllacto-N-hexaose (TFLNH), LnNH, lacto-N-hexaose (LNH), lacto-N-fucopentaose III (LNFPIII), monofucosylated lacto-N-Hexose III (MFLNHIII), Monofucosylmonosialyllacto-N-hexose MFMSLNH). In some embodiments, the GOS preferably has a degree of polymerization (DP) of larger than at least 4 (DP4), DP5 or DP6. In some embodiments, the DP4 is at least 30% of the total GOS provided. In others D4 and D5 make up at least 50% of the GOS Composition. In some embodiments, the GOS has less than 10% DP3 (WO 2010/105207, published Sep. 16, 2010 incorporated here by reference). In some embodiments, a ratio of GOS/FOS, GOS/inulin, GOS/FOS/inulin, GOS/PDX is used with one or more mammalian milk oligosaccharides.

In some embodiments, at least one of the oligosaccharide is a human milk oligosaccharide. In some embodiments, the oligosaccharide is selected from lacto-N-tetraose (LNT) or lacto-N-neotetraose (LNnT). In other embodiments, both LNT and LnNT are found in the composition, wherein the ratio of LNT to LnNT is preferably a ratio of LNT relative to LNnT at 1:1, 1.5:1, 2:1, or greater. In some of these embodiments, the composition further comprises at least one of 2′FL, 3′FL, LNFPI , LNFPII, LNB, N-acetyl lactosamine, 3′SL or 6′SL

In some embodiments, there are at least 2 or at least 3 synthetic oligosaccharides in the composition. In some embodiments, the added total dietary oligosaccharides can come from a combination of partially purified OS from human milk products, human milk, bovine, caprine, or human or bovine glycoproteins, and synthetic single source oligosaccharides.

In some embodiments, the infant formula is carefully formulated to provide only oligosaccharides selective for B. infantis. In other words, for use in or for use with formula's that do not contain galacto-oligosaccharides (GOS), inulin (short or long chain), Fructo-oligosaccharides (FOS), short or long chain inulin, or polydextrose (PDX) or maltodextrin.

The compositions may be mixed with ingredients comprising soy, such as but not limited to soy lecithin, soy peptides, soy protein. Proteins may be partially or extensively hydrolyzed, or may be in the form of amino acids, such as, but not limited to taurine, leucine, and tryptophan. In other embodiments, indole lactate or other tryptophan derivatives are added to the composition. In some embodiments, the diet comprises at least a source of tryptophan.

In some embodiments, the compositions may be mixed with ingredients comprising minerals such as, but not limited to calcium phosphate, and/or selenium.

In yet other embodiments, compositions may be mixed with ingredients comprising oils such as but not limited to palm olein, soy oil, coconut oil, high oleic sunflower oils, and oils rich in docosahexaenoic acid (DHA) arachidonic acid (ARA).

In some embodiments, the compositions may be mixed with ingredients comprising vitamins such as, but not limited to, vitamin A palmitate, vitamin D3, vitamin E acetate, and/or vitamin K.

In some embodiments, the compositions may be mixed with ingredients comprising lactose, sialic acid, fucose, glucose and/or galactose.

In some embodiments, the compositions are mixed with ingredients comprising nucleotides.

Complexes Containing rSIgA

Any of the embodiments above may also contain recombinant secretory IgA (rSIgA). These embodiments require adding the rSIgA and either keeping it in an aqueous form or drying the entire mixture by an appropriate drying method such as, but not limited to freeze drying, spray drying, vacuum drying, tumble drying, and fluid bed drying. The rSIgA may be targeted to specific enteropathogens or may have a mixture of specificities. Targets for rSIgA include pathogenic bacteria, viruses and fungi.

Recombinant secretory IgA (rSIgA) can be produced according to methods such as those of Moldt (Methods. 2014 Jan. 1;65(1):127-32. doi: 10.1016/j.ymeth.2013.06.022. Epub 2013 Jun. 25.). Using such, or substantially similar methods one skilled in the relevant art will be enabled to create and use any targeted SIgA referenced herein. The rSIgA can be specific for an antigen from a pathogenic organism such as, but not limited to, yeast, mold, viruses or bacteria. The pathogenic bacteria may include, but not limited to, Clostridium, Escherichia, Klebsiella, Vibrio, and Enterobacteria. Pathogenic viruses may include, but not limited to, Norovirus, Rhinovirus, Rotavirus, Enterovirus, Adenovirus, Influenza, SRS. In certain instances, the recombinant SIgA is developed with an epitope targeted for a particular antigen, such as an enterotoxin, a surface protein, such as those involved in adhesion or invasion of the organism. One skilled in the art would look to develop a recombinant sIgA with an epitope that reacts in the first instance to neutralize a toxin, such as, but not limited to the following enterotoxins, cytotoxins or exotoxins: Clostridium enterotoxin from Clostridium perfringens, Cholera toxin from Vibrio cholerae, Staphylococcusenterotoxin B from Staphylococcus aureus, Shiga toxin from Shigella dysenteriae, or those from Bacillus cereus, or Toxin A or B from Clostridium difficile (https://www.mdpi.com/2073-4468/3/4/272/htm).

In other instances, sub-acute or chronic presence of these species with or without symptoms may favor development and use of different surface proteins, such as those involved in adhesion or invasion of the organism in the patient to reduce their ability to maintain a niche in the intestinal microbiome of a patient in need of correcting dysbiosis or improving their health. In the case of C. difficile, efforts to direct epitopes towards certain cell surfaces (https://www.ncbi.nlm.nih.gov/pmc/articles/PMC5974105/) may be used in compositions described herein. A similar approach can be taken for virus examples include rotavirus non-structural protein NSP4 or Influenza A Virus Hemagglutinin (https://www.ncbi.nlm.nih.gov/pmc/articles/PMC4389908/) or HIV (https://www.ncbi.nlm.nih.gov/pmc/articles/PMC4622858/)

The rSIgA may be a cocktail of different recombinant IgA to target common exposure risk in a particular geographic environment, such as but not limited to resource limited countries where hygiene factors such as lack of clean water pose serious health hazards; hospital environments with high prevalence of antibiotic or multiple antibiotic resistant strains.

The MFGM may be bound to the rSIgA via an O-linked glycosylation site. The rSIgA may be coated in triglycerides and used to fill the liposome where the combined rSIgA and MFGM are in a ratio of from 1:1,000,000 to 1,000,000:1.

In yet another embodiment, the recombinant sIgA undergoes: 1) a deglycosylation step to remove O-glycans added during yeast or E. coli synthesis; and 2) a glycosylation step to add humanized N-glycans to the Fc Binding site. In other embodiments, the MFGM contains 2 different tethering points, one for the desired secretory IgA using an O-linked mechanism that is the natural pattern for recombinant proteins and another glycan and/or solute binding protein that binds activated B. infantis to the surface of the MFGM. The composition containing a commensal organism with an appropriate tethering point for that organism, and an SIgA are then dried under suitable conditions. This composition may be delivered in a sachet, stick pack or any other storage devices that retain low water activity and have oxygen barrier properties.

### Use of the Complexes

MFGM may be used to tether a selected enzyme or protein of interest. The enzyme would have a transmembrane domain and an extracellular active site. MFGM may also be a repository for delivery of glycoproteins that can be cleaved by certain commensal organisms such as, but not limited to B. infantis to release glycans that can support the growth of B. infantis, and/or anti-microbial peptides at the target site.

The MFGM complex may be used as a food for human or animal consumption. For a nursing mammal, a weaning mammal, or an adult mammal or for performance improvements i.e human or animal athlete, or for increasing growth rate i.e yield in food production animals, or to improve the health of an animal or human suffering from a disorder that may stem from the microbiome.

In some embodiment the compositions are provided to protect the gut from opportunistic pathogen invasion. In some embodiments, colonization of the commensal organism provided is increased and pathogens or potential pathogens are reduced (i.e provides colonization resistance). In another embodiment the compositions are provided to mammals to lower the pH of the gut. In another embodiment the compositions are provided to infant mammals to reduce the carriage of antibiotic resistant genes and/or levels of endotoxin and/or chronic gut inflammation.

Any of the MFGM complexes described herein may be administered to treat or prevent disorders such as late on-set sepsis, necrotizing enterocolitis, colic, diaper rash, celiac disease, inflammatory bowel diseases (Crohn's, ulcerative colitis,) inflammatory bowel syndrome (IBS), Multiple sclerosis, Type 1 diabetes, Type 2 diabetes, obesity, psoriasis, atopic dermatitis, asthma; food allergies; and severe acute malnutrition; stunting; acute recurrent infections like C. difficile or multiple antibiotic resistant infections.

The compositions may be tailored or targeted to specific age groups, such as a preterm infant who may be born with a gestational age of less than 33 weeks, the preterm babies may be a very low birth weight (VLBW), or low birth weight (LBW), a term infant (0-3 months), an infant 3-6 months, an infant (6-12 months), a weaning infant (4-12 months), a weaned infant (12 months to 2 years) and child (1-16 years), an adult (16-70 yr), or an older adult (70-100+yr).

In certain embodiments, the MFGM complex compositions described herein are provided daily for at least 1 day, at least 3, at least 7, at least 14, at least 28 days, at least 3 months, at least 6 months or at least 12 months to any subject in need of In some embodiments, infants are fed MFGM complex compositions when the adaptive immune system is developing preferably starting at birth, in the first 100 days of life, the first 6 months of life or in the first year of life wherein the compositions are provided daily for at least 1 day, at least 3, at least 7, at least 14, at least 28, at least 3 months, at least 6 months or at least 12 months.

The MFGM complex may be used by supplementing an existing nutrient source, such as human milk, infant formula, or any meal replacer. The MFGM complex may be incorporated as part of a complete nutrition source, such as infant formula, follow-on formula, meal replacer, formula for enteral feeding, or a prepared food. In other instances, the MFGM complex is added to the nutrition source just prior to consumption by an individual. In yet other instances it is taken alone with water (i.e non-nutritive sources).

The compositions may be tailored or targeted to specific geographic areas to address issues of severe acute malnutrition, diarrheal diseases.

Non-human mammals may include, but are not limited to, horses, cows, goats, sheep, pigs, dogs, cats, camels. Compositions may be used to combat stress and effects of travel as well as diarrheal diseases caused by for example C. difficile.

In any of the foregoing embodiments, the mixing of the ingredients with the compositions of oligosaccharides and bioactive proteins may occur during the manufacturing process or may be added prior to consumption or may be delivered as separate servings as part of a complete diet, such that the composition is added to the total daily dietary intake of proteins and oligosaccharides regardless of when other nutrients are delivered.

The formulation may be used in a pharmaceutical preparation, such as an oral treatment.

### EXAMPLES

Example 1. Preparation of a MFGM composition comprising LNT and B. infantis. Milk fat globules (MFG) are isolated from cow's milk by centrifugation following the process of Patton and Huston (Lipids 1986 21:170-174) or can be obtained directly from Arla Food Ingredients (Aarhus, DK). Fifteen grams of an aqueous mixture of MFG (water: lipid ratio of about 2:1) is mixed with 5 g of LNT and 1 g of a dried stabilized culture of B. infantis EVC001 at 100 B CFU/g (obtained from Evolve Biosystems Inc, Davis Calif. USA, as described in PCT/US2019/034765 (E29)) at a temperature of 10 C. The mixture is sonicated for 1-2 min to ensure the disruption of the MFG, incorporation of the bacteria in the milk oil, and resealing of the liposomes. The sonicate is immediately frozen in liquid nitrogen and the water is removed by vacuum. This produces about 11 g of a final dried product which is milled to a powder while frozen and is about 45% MFG liposomes, 45% LNT and 10% lactose and has a B. infantis content of about 9 billion cfu/g.

Example 2. Preparation of a MFGM composition comprising Oligosaccharides, B. infantis and L. plantarum. MFGM is obtained directly from Arla Food Ingredients (Aarhus, DK) as the commercial product Lacprodan® MFGM-10. Ten grams of dry powder MFGM is blended with 10 ml of Medium Chain Triglyceride oil (ConnOils; Big Bend Wisc., USA) containing 50 B CFU/g oil of each of a dried stabilized culture of B. infantis EVC001, and L. plantarum (obtained from Evolve Biosystems Inc, Davis Calif. USA) and 20 ml of distilled water at a temperature of 10 C. The composition is mixed in a high-speed blender for 30 sec to ensure the disruption of the MFGM and incorporation of the MCT oil and bacteria in into liposomes. Five grams of LNnT and five grams of GOS is then added to the mixture and blended for an additional 30 sec. The emulsion of liposomes is then immediately frozen in liquid nitrogen and the water is removed by vacuum. This produces about 30 g of a final dried product, which is milled to a powder while frozen. The final product contains about 30-35% MFGM, 30-35% MCT oil, 15-17% LNnT, and 15-17% GOS, and has a B. infantis and L. plantarum content of about 10B cfu/g of each.

Example 3. Preparation of a formulation containing rSIgA filled globules in MCT oil and B. infantis into single serve vials. A preparation of MFG as in Example 1 is mixed with a solution containing a rSIgA targeted for E. coli. An effective volume of a solution containing the rSIgA bound to the MFG is added to a vial containing 8 Billion CFU of B. infantis in 0.5 ml of MCT oil. The final vial contains inverted milk fat globules such that the rSIgA is found inside the globule and the B. infantis is outside. The process of assembling the final product requires one or more steps to avoid contamination, such as pasteurizing or otherwise treating, the MFGM. The pasteurized MFGM is disrupted to allow for new functions to be added to the structure. The MFGM is mixed with suitable enzymes and proteins with desired glycan structures as needed for the specific formulation to form globules enriched with desired functionality for the target application. Once the globules are formed the sIgA is bound to the glycan structures. The MFGM-sIgA mixture is then concentrated to remove most of the aqueous phase and quickly added to a vessel containing a homogeneous mixture of B. infantis and prefiltered MCT oil. The globules quickly invert to push the sIgA into the inside and leave the lipid portion.

Example 4. Using MFGM complexes to facilitate change in the pattern of pro-inflammatory cytokine production from intestinal epithelial cells. MFGM complexes are added to intestinal epithelial cell monolayers (HT-29, T-84), and cytokine profiles (IL-8, IL-10, TNFalpha), cDNA (ZO-1, occludins, TLRs, cox-2) and key proteins (ZO-1, p65) demonstrate significant reductions in inflammatory markers after incubation. Pathogen-associated molecular pattern (PAMP; i.e. LPS, Pam3CSK4)-induced pro-inflammatory cytokine production is also reduced in intestinal epithelial cells.

1. A composition comprising a milk fat globule membrane complex (MFGM), further comprising at least one Bifidobacterium species or subspecies, secretory immunoglobulin A (sIgA), or both.

2. The composition of claims 1, wherein the MFGM is derived from a mammalian source.

3. The composition of claim 1 or 2, wherein the source of MFGM is from processing of buttermilk.

4. The composition of claim 1, wherein the MFGM is formed by contacting glycolipids, phospholipids, and glycoproteins.

5. The composition of any preceding claims, wherein the MFGM comprises oil.

6. The composition of claim 5, wherein the oil is selected from food-grade plant, animal, or microbial oil wherein such oil is optionally selected from MCT oil, sunflower oil, DHA- or ARA-rich oils, and/or mineral oil.

7. The composition of any preceding claim, wherein the MFGM is purified and/or dried.

8. The composition of any preceding claim, comprising a MFGM and further comprising secretory IgA (sIgA).

9. The compositions of claim 8, wherein the secretory IgA is purified from a mammalian milk.

10. The compositions of claim 8 or 9, wherein the sIgA is produced from a bovine source.

11. The compositions of claim 8, wherein the sIgA is from a recombinant source.

12. The composition of claim 11, wherein the sIgA is produced in cell culture, wherein the cell culture is a recombinant mammalian, bacterial, yeast, or fungal cell culture.

13. The compositions of any of claims 8-12, wherein the sIgA is present in a mixture containing different paratopes of sIgA.

14. The composition of any of claims 7-13, wherein the sIgA is specific for an antigen on pathogenic bacteria, viruses, or fungi.

15. The composition of claim 14, wherein the sIgA is specific for organisms in the phylum Firmicutes.

16. The composition of claim 14 wherein the sIgA is specific for organisms in the genus Enterococcus.

17. The composition of claim 14 wherein the sIgA is specific for Clostridium difficile.

18. The composition of claim 14 wherein the sIgA is specific for rotavirus.

19. The composition of claim 14 wherein the sIgA is specific for Malassezia.

20. The composition of claim 14, wherein the mixture comprising sIgA is specifically tailored to the microorganisms commonly found in a geographic region.

21. The composition of claim 14 wherein the mixture comprising sIgA is specific to a known infection by bacterial or viral pathogens or exposure to toxins in a patient's gut microbiome, optionally where the pathogen is C. difficile or MRSA.

22. The composition of any of claims 8-19, wherein the sIgA is selected to specifically target a microorganism found to be resistant to antibiotic treatment.

23. The composition of any of claims 8-22, wherein the sIgA is bound to the MFGM.

24. The composition of claim 23, wherein the sIgA is bound to MFGM via O-linked glycans, but not via its epitope binding site.

25. The composition of any of claims 8-24, wherein the sIgA and MFGM form an inside-out MFG in an oil.

26. The composition of any preceding claim comprising a Bifidobacterium, wherein the Bifidobacterium is selected from B. infantis, B. breve, B. bifidum, B. longum, and B. lactis.

27. The composition of claims 26, wherein the Bifidobacterium is B. infantis, and wherein the B. infantis is activated.

28. The composition of any of claim 26 or 27, wherein the B. infantis is H5 competent, optionally wherein the H5 competent B. infantis is B. infantis EVC001.

29. The composition of any of claims 26-28, wherein the Bifidobacterium or the MFGM and the Bifidobacterium are dried.

30. The composition of any of claims 26-29, wherein the Bifidobacterium is present in an oil suspension, and the oil suspension is encapsulated in the MFGM.

31. The composition of claim 30, wherein the MFGM is filled with the oil suspension comprising B. infantis and is resuspended in an aqueous solution.

32. The composition of any one of claims 26-31, wherein the MFGM filled is with a suspension of a Bifidobacterium in oil, and wherein the MFGM is coated with freeze-dried recombinant sIgA.

33. The composition of claim 32, wherein the MFGM partitions the sIgA from the bacteria.

34. The composition of any of claims 1-33, further comprising a mammalian milk oligosaccharide, GOS, FOS, XOS, and/or PDX.

35. The composition of any of claims 1-34, further comprising one or more glycans selected from the group consisting of lacto-N-biose, N-acetyllactosamine, lacto-N-triose, lacto-N-neotetrose, fucosyllactose, lacto-N-fucopentose, lactodifucotetrose, sialyllactose, disialyllactone-N-tetrose, 2′-fucosyllactose, 3′-sialyllactosamine, 3′-fucosyllactose, 3′-sialyl-3-fucosyllactose, 3′ -sialyllactose, 6′-sialyllactosamine, 6′- sialyllactose, difucosyllactose, lacto-N-fucosylpentose I, lacto-N-fucosylpentose II, lacto-N-fucosylpentose III, lacto-N-fucosylpentose V, sialyllacto-N-tetraose, and/or derivatives thereof.

36. The composition of any of claims 1-35, further comprising one of more N-glycans from soy or whey protein.

37. The composition of any of claims 1-36, further comprising a blend of nutritional components designed for human or animal use.

38. The composition of claim 37, wherein the blend of nutrition components comprises a milk protein, a milk peptide, a vegetable protein, a vegetable peptide, an essential vitamin, or a combination thereof.

39. The composition of any of claims 1-38, further comprising a Lactobacillus and/or Pediococcus.

40. The composition of claim 39, wherein the Lactobacillus species is selected from L. plantarum, L. rhamnosus, and L. reuteri.

41. The composition of claim 39, wherein the Pediococcus species is P. acidiliti.

42. The composition of any of claims 1-41, the composition being in a dried form.

43. A medicament comprising the composition of any of claims 1-42 in the form of a capsule, tablet, or sachet.

44. A medicament comprising the composition of any of claims 1-43 in an oil suspension.

45. A method of preparing MFGM lipids for delivery to the mucous layer of gut epithelium of a mammal, said method comprising the steps of:
a. preparing MFG or MFGM lipids;
b. combining MFG or MFGM lipids with at least one commensal organism and/or recombinant sIgA to produce a composition according to any one of claims 1-42;
c. forming an emulsion of liposomes from the composition; and
d. drying the emulsion to form a dried composition.

46. The method of claim 45, wherein the at least one commensal organism is provided in purified stable form.

47. The method of claim 45 or 46, wherein the at least one commensal organism is selected from the group of Bifidobacterium consisting of B. infantis, B. breve, B. bifidum, B. longum, and B. lactis; from the group of Lactobacillus consisting of L. plantarum, L. rhamnosus, and L. reuteri; or a Pedicoccus consisting of P. acidolacti.

48. The method of claim 47, wherein the commensal organism is B. infantis.

49. The method of claim 48, wherein the B. infantis is activated.

50. The method of any one of claims 45-49, the method further comprising the steps of:
1. producing sIgA in a recombinant bacterial, yeast or fungal system to obtain recombinant sIgA (rsIgA), wherein the rsIgA is specific to an epitope of an antigen; and
2. combining the rsIgA with MFGM in a ratio of from 1:1,000,000 to 1,000,000:1 to produce an rsIgA/MFGM composition.

51. The method of any one of claims 45-50, wherein at least one mammalian milk oligosaccharide, optionally selected from LNB, LNT, LNnT, 3′SL or 6′SL, 2FL or 3-FL, is additionally added prior to the step of emulsification.

52. The method of any one of claims 45-51, further comprising providing the dried composition to a human having chronic gut inflammation.

53. The method of any one of claims 45-52, further comprising delivering a commensal organism to a subject in need of colonization or recolonization with said commensal organism.

54. The method of any one of claims 45-53, further comprising delivering a targeted recombinant IgA to a mucosal membrane of a mammal.

55. The method of any one of claims 45-54, further comprising providing the rsIgA/MFGM composition to a nursing mammal, a weaning mammal, or an adult mammal.

56. A method of inhibiting colonization of a pathogenic organism, the method comprising making a recombinant sIgA to such organism and delivering it to the mucous layer by the method of claim 54.

57. A therapeutic method comprising administering of the composition of any one of claims 1-44 to a mammal.

58. The method of claim 57 wherein the composition is administered to the mammal to treat or prevent intestinal disease caused by a microorganism.

59. A method for treating a mammal for antibiotic-resistant intestinal pathogens, the method comprising administering the composition of any of claims 1-44.

60. A method of inhibiting growth of C. difficile in a person in need thereof, the method comprising administering a composition of any of claims 1-44.

61. A method of reducing inflammation in a person in need thereof, the method comprising administering a composition of any of claims 1-44.

62. The method of any of claims 52-61, wherein administering the composition referenced therein leads to an acidification of the mammal's gut.

63. The method of any of claims 52-62, wherein administering the composition referenced therein leads to improvement of growth rate, optionally characterized by Z scores, selected from WAZ, LAZ or WLZ measurements, of the mammal.

64. The method of any of claims 52-63, wherein the composition is provided to a mammal in need of restoring gut microbiome and/or reducing inflammation.

65. The method of any of claims 52-64, wherein the mammal is a human.

66. The method of claim 65, wherein the human is premature infant, term infant (0-6 mo), a toddler (6-24 mo), a child (2-16 yr), an adult (16-70 yr), or an older adult (70-100 yr).

67. The method of any claims 52-66, wherein the composition is administered to treat or prevent disorders selected from late onset sepsis, necrotizing enterocolitis, colic, diaper rash, celiac disease, inflammatory bowel diseases (Crohn's, ulcerative colitis,), inflammatory bowel syndrome (IBS), multiple sclerosis, Type 1 diabetes, Type 2 diabetes, obesity, psoriasis, atopic dermatitis, asthma, food allergies, and severe acute malnutrition, stunting, or infection.

68. The method of any of claims 52-67, wherein the mammal is a non-human.

69. The method of claim 68, wherein the non-human mammal is selected from a food production, animal, performance animals, or domestic animals, optionally selected from pig, cow, goat, buffalo, horse, dog, or cat.

70. The method of claim 68 or 69, wherein the non-human mammal is protected from disorders optionally from scours, clostridal infections, diarrhea associated with stress, or travel.
